(19) United States
(12) Patent Application Publication
(10) Pub. No.: US 2024/0150630 A1
(43) Pub. Date: May 9, 2024

(54) ADHESIVES FOR FILM LAMINATION AND PRODUCTS MADE THEREFROM

(71) Applicant: Celanese International Corporation, Irving, TX (US)

(72) Inventor: Matthias JUNK, Hahnlein (DE)

(73) Assignee: Celanese International Corporation, Irving, TX (US)

(21) Appl. No.: 18/549,070

(22) PCT Filed: Mar. 21, 2022
(86) PCT No.: PCT/US22/21128

§ 371 Date: Sep. 5, 2023

Related U.S. Application Data
(60) Provisional application No. 63/164,793, filed on Mar. 23, 2021.

(51) Int. Cl. C09J 175/04; B32B 3/30; B32B 7/12; B32B 27/10; B32B 27/16; B32B 27/32; C08F 220/18; C08G 18/62; C08G 18/73; C08K 3/26; C08K 3/30; C08K 3/32; C08K 5/098; C09J 11/04; C09J 11/06

(52) U.S. Cl. CPC C09J 175/04; B32B 3/30; B32B 7/12; B32B 27/10; B32B 27/16; B32B 27/32; C08F 220/1804; C08F 220/1808; C08G 18/6266; C08G 18/73; C08K 3/26; C08K 3/30; C08K 3/32; C08K 5/098; C09J 11/04; C09J 11/06; B32B 2255/10; B32B 2255/12; B32B 2255/26; B32B 2307/4023; B32B 2307/406; B32B 2307/412; B32B 2307/514; B32B 2307/748; C08K 2003/262; C08K 2003/3045; C08K 2003/324

(57) ABSTRACT

Adhesives comprising an aqueous polymer dispersion, at least one cross-linker, and optional additives, are provided for film lamination. The adhesives comprise a polymer dispersion comprising at least one salt, at least one ethylenically unsaturated monomer with at least one keto or aldehyde group, and at least one compound with at least two functional groups that are capable to react with the keto or aldehyde groups. The adhesives advantageously provide a strong connection between a transparent plastic film or foil and a substrate such as paper or cardboard while being safer and cheaper.

### CROSS-REFERENCE TO RELATED APPLICATION

This application claims the benefit of and priority to U.S. Provisional Application No. 63/164,793, filed on Mar. 23, 2021, which is hereby incorporated by reference in its entirety.

### FIELD OF THE INVENTION

The present invention relates generally to adhesives for film lamination, such as high-gloss film lamination. Specifically, the adhesives can bond a substrate such as paper or cardboard with transparent polymer films, for example.

### BACKGROUND OF THE INVENTION

Lamination refers to the process of bonding a film, often a clear plastic film, onto a paper or cardboard substrate to make it stronger and more durable and/or give it a more attractive appearance. The substrate often contains printed matter. In many cases, the bonding is applied to one side of the substrate. This process can protect the substrate from stains, tears, moisture, and other hazards, that could cause damage or destruction of the substrate. Lamination can, in many cases, also add strength and rigidity to a printed substrate and/or make the colors stand out. Lamination is used in a variety of projects and is ideal for print items that are handled, for example, postcards, paperback books, and containers for valuable goods, such as perfume bottles, for example. The aesthetic appearance is often enhanced by embossing techniques.

Such glossy film or film-to-print lamination (FPL) processes also use a laminating adhesive. The laminating adhesive needs to establish a strong connection between the paper or cardboard and the foil.

Lamination tasks involving average paper quality can be performed with a one-component (1k) system, applying an optimized aqueous acrylic dispersion with a special cross-linking system, for example. Higher end lamination tasks often require additional cross-linking through use of up to 5% of a crosslinker (e.g., a diisocyanate or polyisocyanate) in a two-component (2k) process. Since the second cross-linker reacts with the stabilizing carboxylic acid groups of the acrylic dispersion, it significantly reduces the pot life of the dispersion. Therefore, hydroxy-functional monomers are typically incorporated to increase the pot life of the dispersion, since they provide a preferential reaction site for the functional groups (e.g., isocyanate) of the cross-linker. However, hydroxy-functional monomers are expensive, harmful or even toxic, and increase the number of raw materials and the complexity of the production of the acrylic dispersion. Hence, an acrylic dispersion which possesses adequate cross-linker compatibility without the use of hydroxy-functional monomers is desirable.

### SUMMARY OF THE INVENTION

In some aspects, the disclosure relates to adhesives for film lamination, the adhesives comprising at least one aqueous polymer dispersion produced by emulsion polymerization, such as free radically initiated emulsion polymerization, wherein the aqueous polymer dispersion comprises: (1) at least one salt with a solubility in water at 20° C. of greater than 10 g/L, the salt comprising a cation and an anion, wherein the cation of the salt is selected from ammonium, alkali, and alkaline earth, and where the anion of the salt is selected from sulfate, hydrogen sulfate, phosphate, hydrogen phosphate, dihydrogen phosphate, diphosphate, hydrogen/dihydrogen diphosphate, acetate, carbonate, hydrogen carbonate, nitrate, or halogenide; (2) at least one ethylenically unsaturated monomer incorporated into the polymer with at least one keto or aldehyde group in an amount from 0.1 to 5 wt. % (e.g., from 0.3 to 3 wt. % or from 0.5-1.5 wt. %); and (3) at least one compound with at least two functional groups that are capable to react with the keto or aldehyde groups, such as a dihydrazide for example; wherein at least a portion (e.g., at least 50 wt. %, at least 75 wt. %, or all) of the at least one salt is present during the emulsion polymerization process. In some aspects, the at least one salt is present in an amount from 0.05 to 0.5 wt. %, preferably from 0.075 to 0.4 wt. %, more preferably from 0.1 to 0.3 wt. %, based on the total weight of the monomer mixture. In some aspects, the aqueous polymer dispersion also comprises at least one ethylenically unsaturated stabilizing monomer, such as a carboxylic acid like acrylic acid and/or methacrylic acid, for example. In some aspects, the aqueous polymer dispersion comprises methacrylic and acrylic acid esters, such as methyl methacrylate, n-butyl acrylate and/or 2-ethylhexyl acrylate.

In some aspects, the aqueous polymer dispersions described herein do not contain protective colloids, nonionic emulsifiers, and/or ethylenically unsaturated monomers with a hydroxyl group.

With respect to properties, in some aspects the polymer of the aqueous polymer dispersion has a glass transition temperature of −10 to −30° C., preferably −15 to −25° C. In additional aspects, the weight-average particle size of the polymer dispersion is in the range of from 150 to 350 nm, such as in the range of 180 to 300 nm, preferably in the range of 200 to 250 nm. In other aspects, the solid content of the polymer dispersion is from 50 to 60%, such as from 53 to 57% or from 54 to 56%. In some aspects, the Brookfield viscosity of the polymer dispersion is below 1500 mPas, below 1000 mPas, or from 100 to 700 mPas. In other aspects, the coagulum content of the unfiltered polymer dispersion is below 0.02% or below 0.01%, as measured with a sieve with a mesh size of 180 μm.

In some aspects, the disclosure relates to laminated products comprising a substrate such as paper or cardboard; a transparent polymer film; and an adhesive as described herein; where the adhesive bonds the transparent polymer film to the substrate. In some aspects, the laminated product can also comprise at least one additive, such as a filler, dye, leveling agent, thickener, defoamer, plasticizer, pigment, wetting agent, UV stabilizer, biocide, tackifier, or combinations thereof.

### DETAILED DESCRIPTION OF THE INVENTION

Surprisingly, the inventor was able to discover an adhesive for film lamination that comprises an aqueous dispersion (e.g., an aqueous acrylic dispersion) with sufficient crosslinker (e.g., isocyanate) compatibility such that the use of additional functional monomers (e.g., hydroxy-functional monomers) is not required, yet the pot life of the dispersions is satisfactory or better. Specifically, through investigation and experiment, it was found that the crosslinker compatibility of certain dispersions for lamination applications (e.g., glossy film lamination and/or FPL processes), can be improved through the introduction of certain salts during the emulsion polymerization process.

### Definitions and Descriptions

As used herein, the terms “invention,” “the invention,” “this invention” and “the present invention” are intended to refer broadly to all of the subject matter of this patent application and the claims below. Statements containing these terms should be understood not to limit the subject matter described herein or to limit the meaning or scope of the patent claims below.

As used herein, the meaning of “a,” “an,” or “the” includes singular and plural references unless the context clearly dictates otherwise.

All ranges disclosed herein are to be understood to encompass any and all subranges subsumed therein. For example, a stated range of “1 to 10” should be considered to include any and all subranges between (and inclusive of) the minimum value of 1 and the maximum value of 10; that is, all subranges beginning with a minimum value of 1 or more, e.g. 1 to 6.1, and ending with a maximum value of 10 or less, e.g., 5.5 to 10.

As used herein, the “pot life” of a sample can refer to the time it takes before the viscosity of the sample exceeds thrice (3×) its original value or a significant amount of coagulate is observed to form in the sample.

As used herein, a “1K system” can refer to a system with one component (e.g., a laminating adhesive). In some aspects, such a system can have a pot life of 6 months or more.

As used herein a “2K system” can refer to a system with two components (e.g., a laminating adhesive and a crosslinker), which undergo a chemical reaction with each other. In some aspects, the two components of the 2K system can be added together immediately before the application by the end user.

### Adhesive Formulations

The adhesives described herein can involve aqueous polymer dispersion systems which contain polymer particles in disperse distribution as the disperse phase in an aqueous medium. The aqueous polymer dispersions can be prepared as monomer mixtures in an aqueous medium and then polymerized, for example through an emulsion polymerization, to produce the aqueous polymer dispersion. In some aspects, the emulsion polymerization process is a free radically initiated polymerization.

The adhesives described herein can also comprise at least one crosslinker and optional additives in some aspects. In some embodiments, the at least one crosslinker can be a diisocyanate or polyisocyanate.

In some aspects, the pot life of the adhesives described herein can be at least 1 hour, e.g., at least 2 hours, at least 3 hours, at least 4 hours, at least 6 hours, at least 8 hours, at least 12 hours, at least 18 hours, at least 24 hours, at least 36 hours, at least 48 hours, at least 60 hours, or at least 72 hours, when comprising at least one crosslinker (e.g. a diisocyanate or polyisoyanate).

### Aqueous Polymer Dispersion

Monomer Mixture

The monomer mixture of the aqueous dispersion, prior to polymerization, contains at least one monomer capable of polymerization. In some aspects, the monomer mixture does not comprise any ethylenically unsaturated monomers with a hydroxyl group.

In some embodiments, the at least one polymer of the aqueous polymer dispersion can be a (poly)acrylic or (poly)acrylate polymer. Thus, in some embodiments, the monomer mixture of the aqueous dispersion prior to polymerization can comprise at least one (meth)acrylate or (meth)acrylic ester monomer. For example, the monomer mixture can comprise one or more alkyl esters of acrylic acid or methacrylic acid, in some embodiments. Examples of suitable alkyl esters of acrylic acid or methacrylic acid include, without limitation, methyl methacrylate, ethyl methacrylate, isopropyl methacrylate, isobutyl methacrylate, tert-butyl methacrylate, tert-butyl acrylate, n-propyl methacrylate, isobutyl methacrylate, cyclohexyl methacrylate, methyl acrylate, ethyl acrylate, n-propyl acrylate, isopropyl acrylate, n-butyl methacrylate, n-butyl acrylate, isobutyl acrylate, 1-hexyl acrylate, 2-ethylhexyl acrylate, heptyl acrylate, n-octyl acrylate, and all combinations thereof. In light of the global efforts to replace fossile fuel-based materials by renewable materials, it may be beneficial in some embodiments to utilise (meth)acrylic monomers that are at least partly biorenewable. Non-limiting examples of such at least partly biorenewable (meth)acrylic monomers include isobornyl acrylate, isobornyl methacrylate, 2-octyl acrylate, n-dodecyl methacrylate, n-dodecyl acrylate, tridecyl methacrylate and other (meth)acrylic acid esters of biobased alcohols.

In some embodiments, the alkyl esters of acrylic acid or methacrylic acid are chosen from methyl methacrylate, butyl acrylate, 2-ethylhexyl acrylate, and all combinations thereof. In some embodiments, the monomer mixture comprises methyl methacrylate. In some embodiments, the monomer mixture comprises n-butyl acrylate or 2-ethylhexyl acrylate. In some embodiments, the monomer mixture comprises methyl methacrylate and n-butyl acrylate. In other embodiments, the monomer mixture comprises methyl methacrylate and 2-ethylhexyl acrylate. In some embodiments, the monomer mixture comprises methyl methacrylate, n-butyl acrylate and 2-ethylhexyl acrylate.

In some aspects, the monomer mixture comprises at least 80 wt. % esters of acrylic or methacrylic acid based on the total weight of the monomer mixture, e.g., at least 85 wt. %, at least 90 wt. %, at least 95 wt. %, at least 96 wt. %, at least 97 wt. %, or at least 98 wt. %. In terms of ranges, the monomer mixture comprises from 60 wt. % to 99 wt. % esters of acrylic or methacrylic acid based on the total weight of the monomer mixture, e.g., from 70 wt. % to 99 wt. %, from 80 wt. % to 99 wt. %, from 85 wt. % to 99 wt. %, from 85 wt. % to 98 wt. %, from 90 wt. % to 99 wt. %, from 95 wt. % to 99 wt. %, or from 95 wt. % to 98 wt. %, in some embodiments.

In addition to the above, in some embodiments, the monomer mixture can optionally contain one or more polymerizable ethylenically unsaturated co-monomers. In some cases, these can be referred to as block-building co-monomers. Suitable other polymerizable ethylenically unsaturated block-building co-monomers include, without limitation, nitriles, such as acrylonitrile and methacrylonitrile, vinyl and vinylidene halides, such as vinyl chloride and vinylidene fluoride, and vinyl esters, such as vinyl acetate, among other monomers. Other suitable block-building co-monomers include vinyl aromatic monomers, which may include vinyl esters of benzoic acid, substituted derivatives of benzoic acid, such as vinyl p-tert-butylbenzoate, styrene and styrene derivatives, for example. If present, these co-monomers are present in an amount less than 10 wt. % based on the total weight of the monomer mixture, e.g., less than 7.5 wt. %, less than 5 wt. %, less than 2.5 wt. %, or less than 1 wt. %. Preferably, these co-monomers are present in amount less than 5 wt. % based on the total weight of the monomer mixture. More preferably, these co-monomers are not present in the monomer mixture.

In some aspects, the monomer mixture of the aqueous dispersion prior to polymerization comprises at least one ethylenically unsaturated monomer with at least one keto or aldehyde group. Suitable examples of these co-monomers include, without limitation, polymerizable derivatives of diacetone, for example diacetone acrylamide (DAAM) and diacetone methacrylamide, butanonemethacrylic esters, polymerizab 1e 1,3-dicarbonyl compounds, for example acetoacetoxyethyl acrylate, acetoacetoxyethyl methacrylate (AAEM), acetoacetoxypropyl methacrylate, acetoacetoxybutyl methacrylate, 2,3-di(acetoacetoxy)propyl methacrylate and allyl acetoacetate, polymerizable 1,3-diketoamides (such as those compounds described in U.S. Pat. No. 5,889,098, which patent is incorporated herein by reference), and combinations thereof. Examples of suitable 1,3-diketoamides include amido acetoacetonates such as 3-isopropenyl-α,α-dimethylbenzyl amidoacetoacetate, 4-isopropenyl-α,α-dimethylbenzyl amidoacetoacetate, 4-ethylenyl-phenyl amidoacetoacetate and the like. In one preferred embodiment, the at least one ethylenically unsaturated monomer with at least one keto or aldehyde group is diacetone acrylamide.

In some embodiments, the monomer mixture of the aqueous dispersion prior to polymerization comprises at least one ethylenically unsaturated monomer with at least one keto or aldehyde group in an amount from 0.1 to 5 wt. % based on the total weight of the monomer mixture, e.g., from 0.2 to 3 wt. %, from 0.3 to 2 wt. %, or from 0.5 to 1.5 wt. %.

In some embodiments, the monomer mixture prior to polymerization can comprise at least one ethylenically unsaturated stabilizing monomer. In one embodiment, the at least one ethylenically unsaturated stabilising monomer is selected from the group consisting of ethylenically unsaturated sulfonic acids, ethylenically unsaturated phosphonic and phosphoric acids, ethylenically unsaturated carboxylic acids, ethylenically unsaturated carboxylic amides, ethylenically unsaturated carboxylic anhydrides and mixtures thereof. For example, the stabilizing monomer may comprise an ethylenically unsaturated C₃-C₈ monocarboxylic acid and/or an ethylenically unsaturated C₄-C₈ dicarboxylic acid, together with the anhydrides or amides thereof. Examples of suitable ethylenically unsaturated C₃-C₈ monocarboxylic acids include acrylic acid, methacrylic acid and crotonic acid. Examples of suitable ethylenically unsaturated C₄-C₈ dicarboxylic acids include maleic acid, fumaric acid, itaconic acid and citraconic acid. Examples of suitable ethylenically unsaturated sulfonic acids include those having 2-8 carbon atoms, such as vinylsulfonic acid, 2-acrylamido-2-methylpropanesulfonic acid, 2-acryloyloxyethanesulfonic acid and 2-methacryloyloxyethanesulfonic acid, 2-acryloyloxy- and 3-methacryloyloxypropanesulfonic acid. Examples of suitable ethylenically unsaturated phosphonic or phosphoric acids include vinylphosphonic acid, esters of phosphonic or phosphoric acid with hydroxyalkyl(meth)acrylates and ethylenically unsaturated polyethoxyalkyletherphosphates. In addition to or instead of the above acids, it is also possible to use the salts thereof, preferably the alkali metal or ammonium salts thereof, particularly preferably the sodium salts thereof, such as, for example, the sodium salts of vinylsulfonic acid and of 2-acrylamidopropanesulfonic acid.

Preferably, the at least one stabilizing monomer comprises acrylic acid, methacrylic acid, and mixtures thereof. Methacrylic acid is particularly preferred.

In some embodiments, the monomer mixture prior to polymerization can comprise at least one ethylenically unsaturated stabilizing monomer in an amount from 0.2 to 10 wt. % based on the total weight of the monomer mixture, e.g., from 0.4 to 7.5 wt. %, from 0.5 to 5 wt. %, from 1 to 5 wt. %, from 1.5 to 4 wt. %, or from 2 to 4 wt. %. Thus, in some embodiments, the monomer mixture can comprise from 0.05 to 10 wt. %, e.g., from 0.1 to 7.5 wt. %, from 0.1 to 5 wt. %, from 0.3 to 5 wt. %, from 0.5 to 5 wt. %, from 0.7 to 5 wt. %, from 1 to 5 wt. %, from 1 to 4 wt. %, from 1.5 to 4 wt. %, or from 1.5 to 3 wt. %, of acrylic and methacrylic acid based on the total weight of the monomer mixture.

In some embodiments, the monomer mixture can optionally contain further functional co-monomers, including, for example, unsaturated silane co-monomers, epoxy-functional co-monomers, ureido co-monomers, polyfunctional co-monomers and combinations of these optional functional co-monomers.

In addition to the monomers described herein, the polymer dispersion also contains a cross-linking agent, which is preferably added after polymerization of the monomer composition. Such a cross-linking agent can react with specific polymer functionalities, such as keto groups, for example. In some embodiments, the cross-linking agent can react with specific polymer functionalities as water is removed from the polymer dispersion and as a film is formed from the polymerized components. In some embodiments, the cross-linking agent can be a water-soluble cross-linking agent.

Suitable cross-linking agents that can be used in the compositions herein comprise polyfunctional carboxylic hydrazides and/or polyfunctional amines, where the molar ratio of hydrazide and/or amine groups to keto groups in the polymer dispersion ranges from 0.5:1 to 2:1.

Examples of suitable polyfunctional carboxylic hydrazides are dihydrazide compounds of aliphatic dicarboxylic acids of 2 to 10, in particular 4 to 6, carbon atoms, e.g., oxalic acid dihydrazide, malonic acid dihydrazide, succinic acid dihydrazide, glutaric acid dihydrazide, adipic acid dihydrazide, sebacic acid dihydrazide, maleic acid dihydrazide, fumaric acid dihydrazide and/or itaconic acid dihydrazide. Water-soluble aliphatic dihydrazines of 2 to 4 carbon atoms, e.g., ethylene-1,2-dihy drazine, propylene-1,3-dihydrazine or butylene-1,4-dihydrazine, are also suitable. Adipic acid dihydrazide (ADH) is a preferred water-soluble cross-linking agent for use in the compositions herein, especially those produced from monomer compositions which comprise diacetone acrylamide (DAAM).

Examples of suitable polyfunctional amines include ethylene diamine and hexamethylene diamine. Such cross-linking agents are preferred in combination with polymers which comprise a monomer comprising 1,3-dicarbonyl groups, such as acetoacetoxyethyl methacrylate (AAEM).

The polymer dispersion also comprises at least one salt as described below. In some embodiments the at least one salt can be added to a reactor pre-charge (e.g., before the monomer mixture).

Salt

It was discovered that the isocyanate compatibility of certain dispersions can be improved through the introduction of specific salts during the emulsion polymerization process.

Specifically, in some embodiments, the salt can be at least one salt with a solubility in water at standard conditions of 5 g/L or greater, e.g., 10 g/Lor greater, 25 g/L or greater, or 50 g/L or greater.

In some embodiments, the salt can be at least one salt selected from any of sodium, potassium, and ammonium salts of any of carbonic acid, sulfuric acid, phosphoric acid, hydrochloric acid, acetic acid, and formic acid, including all combinations thereof.

In some embodiments, the salt can be at least one salt having a cation and an anion both chosen from Table 1 below. In certain aspects, the salt can be a salt selected from any cation and anion combination in Table 1.

TABLE 1

| Cations | Anions |
|---|---|
| Ammonium | Sulfate, hydrogen sulfate |
| Alkali | Phosphate, hydrogen phosphate, dihydrogen phosphate, |
| | diphosphate, hydrogen/dihydrogen diphosphate |
| Alkaline earth | Acetate |
| | Carbonate, hydrogen carbonate |
| | Nitrate |
| | Halogenide, preferably chloride |

In some embodiments, the salt has a cation that is preferably an alkali, more preferably sodium or potassium, or most preferably sodium. In certain embodiments, the salt has an anion that is preferably an inorganic salt, or more preferably carbonate or hydrogen carbonate. In some preferred embodiments, the salt can comprise a cation and an anion chosen from any of those listed in this paragraph.

In some embodiments, the at least one salt can comprise sodium hydrogen carbonate, sodium acetate, sodium sulfate, or sodium dihydrogenphosphate. In other embodiments, the at least one salt can comprise disodium hydrogen phosphate. In a preferred embodiment, the at least one salt can comprise sodium carbonate or sodium bicarbonate. In another preferred embodiment, the salt can be sodium bicarbonate.

It is important to note that the salt does not include common oxidizer salts or initiators such as persulfates, for example, and common reducer salts such as sulfinates, metabisulfite or (sodium) erythorbate, citrate, or tartrate for example. These redox salts, often used in emulsion polymerizations as initiators or reducing agents, are incorporated into the polymer chain and do not provide the aforementioned benefits. Similarly, the salt does not include emulsifier salts such as the salts of fatty acids, phosphate esters, or sulfate esters, for example.

In some embodiments, the amount of the salt present in the dispersion can be from 0.05 to 0.5 wt. %, based on the total weight of monomers in the dispersion, e.g., from 0.05 to 0.40 wt. %, from 0.075 to 0.40 wt. %, from 0.075 to 0.30 wt. %, from 0.1 to 0.30 wt. %, or from 0.10 to 0.25 wt. %, for example.

In some embodiments, at least 50 wt. % of the salt, based on the total amount of salt added, is added prior to polymerization or is present during polymerization, e.g., at least 75 wt. %, or at least 90 wt. %. In some embodiments, all of the salt is added prior to polymerization or is present during polymerization.

In some aspects, 50 wt. % or greater of the total amount of added salt is present in the water phase (pre-charge) of the emulsion polymerization composition, e.g., greater than 75 wt. % or 90 wt. % or greater. In a preferred embodiment, the total amount of added salt is all present in the water phase.

### Preparation of Aqueous Polymer Dispersion

The polymer dispersions disclosed herein may be prepared by the customary processes of emulsion polymerization, where the monomers may be emulsified in the aqueous phase in the presence of emulsifiers, initiators, and optionally protective colloids, and are advantageously polymerized at temperatures from 60° C. to 95° C. These processes are familiar to those skilled in the art and may be carried out by batch processes, metered-monomer processes, or emulsion-feed processes. The emulsion-feed process allows a small amount of the monomers to be pre-polymerized and then the remainder of the monomers is metered in the form of an aqueous emulsion. The process may involve polymerization in one, two, and more stages with different monomer combinations. Preferably, a single stage polymerization is performed, producing a homogeneous polymer dispersion with one defined glass transition temperature.

Polymerization is initiated by methods known in the art, for example by free radical emulsion polymerization. In some aspects, the dispersion is adjusted to slightly acidic pH values such as from 5 to 7. This can be accomplished by, for example, the addition of an organic or inorganic base, such as an amine, ammonia or an alkali metal hydroxide, such as sodium or potassium hydroxide. In some embodiments, it is preferred to effect neutralization with ammonia.

The initiators may include, without limiting the scope of the embodiments of the disclosed invention, one or more free radical initiators. Suitable free radical initiators include hydrogen peroxide, benzoyl peroxide, cyclohexanone peroxide, isopropyl cumyl hydroperoxide, persulfates of potassium, persulfates of sodium and persulfates of ammonium, peroxides of saturated monobasic aliphatic carboxylic acids having an even number of carbon atoms and a C₈-C₁₂ chain length, tert-butyl hydroperoxide, di-tert-butyl peroxide, diisopropyl percarbonate, azoisobutyronitrile, acetylcyclohexanesulfonyl peroxide, tert-butyl perbenzoate, tert-butyl peroctanoate, bis(3,5,5-trimethyl)hexanoyl peroxide, tert-butyl perpivalate, hydroperoxypinane, p-methane hydroperoxide. The above-mentioned compounds can also be used within redox systems, using transition metal salts, such as iron(II) salts, or other reducing agents. Alkali metal salts of oxymethane sulfinic acid, hydroxylamine salts, sodium dialkyldithiocarbamate, sodium bisulfite, ammonium bisulfite, disodium 2-hydroxy-2-sulfinic acetic acid, disodium 2-hydroxy-2-sulfonic acetic acid, sodium dithionite, diisopropyl xanthogen disulfide, ascorbic acid, tartaric acid, and isoascorbic acid can also be used as reducing agents.

Based on the content of polymer, the polymer dispersions preferably comprise 0.3-3 wt. %, e.g., 0.5-2 wt. %, such as 0.7-1.5 wt. %, preferably 0.75-1.25 wt. % of ionic emulsifiers, and/or no more than 4 wt. %, e.g., no more than 2 wt. %, such as no more than 1 wt. %, preferably no more than 0.5 wt. % of nonionic emulsifiers, based on the total amount of monomers.

Examples of suitable nonionic emulsifiers are alkyl polyglycol ethers, e.g., ethoxylation products of lauryl, oleyl, or stearyl alcohol, or mixtures of the same, e.g., coconut fatty alcohol; and ethoxylation products of polypropylene oxide. Also, copolymerizable nonionic surfactants can be employed. Preferably, no alkylphenol ethoxylates are used.

Suitable ionogenic emulsifiers are anionic emulsifiers, e.g., the alkali metal or ammonium salts of alkyl-, aryl- or alkylaryl sulfonates or -phosphonates, or of alkyl, aryl, or alkylaryl sulfates, or of alkyl, aryl, or alkylaryl phosphates, or compounds with other anionic end groups, and it is also possible here for there to be oligo- or polyethylene oxide units between the hydrocarbon radical and the anionic group. Typical examples are sodium lauryl sulfate, sodium undecyl glycol ether sulfate, sodium lauryl diglycol sulfate, sodium tetradecyl triglycol sulfate, sodium dodecylbenzenesulfonate. Also, copolymerizable anionic surfactants may be used. Preferably, no alkylphenol ethoxylates including derivatives thereof are employed.

In some embodiments, the polymer dispersions and compositions containing such dispersions described herein can be substantially free of protective colloids as stabilising agents. Examples of protective colloids include carboxymethyl cellulose (CMC), hydroxyethyl cellulose (HEC), and polyvinyl alcohol (PVOH). Such polymer dispersions are considered to be “substantially free” of protective colloids when protective colloids comprise no more than 0.5 wt. %, e.g., no more than 0.2 wt. % or no more than 0.1 wt. %, based on the total amount of monomers in the polymer dispersion.

In a particularly preferred embodiment, the dispersions comprise neither protective colloids nor nonionic emulsifiers. In some preferred embodiments, the aqueous polymer dispersion does not contain any ethylenically unsaturated monomers comprising a hydroxyl group, protective colloids, or nonionic emulsifiers.

In some embodiments, it may be desirable to reduce the molecular weight by using from 0.05 to 3 pphm, such as from 0.1 to 1 pphm, of a chain transfer agent. Suitable chain transfer agents are normally water insoluble and include mercaptans and particularly alkyl thiols, such as methylthiol, ethylthiol, n-propylthiol, n-butylthiol, n-hexylthiol, n-octylthiol, n-decylthiol, n-dodecylthiol, n-tetradecylthiol, n-hexadecylthiol, n-octadecylthiol, cyclohexylthiol, isopropylthiol, tert-butylthiol, tert-nonylthiol, and tert-dodecylthiol.

On completion of the polymerization, a further, preferably chemical after-treatment, especially with redox catalysts, for example combinations of the above-mentioned oxidizing agents and reducing agents, may follow to reduce the level of residual unreacted monomer on the product. In addition, residual monomer can be removed in known manner, for example by physical demonomerization, i.e. distillative removal, especially by means of steam distillation, or by stripping with an inert gas. A particularly efficient combination is one of physical and chemical methods, which permits lowering of the residual monomers to very low contents (<1000 ppm, preferably <100 ppm).

### Polymer and Dispersion Properties

In certain embodiments, at least one polymer of the aqueous polymer dispersion can have a glass transition temperature (Tg) of from −5 to −40° C., e.g., from −10 to −30° C., from −15 to −25° C., as determined by differential scanning calorimetry according to ISO 16805.

In some embodiments, the weight average particle size of the aqueous polymer dispersion can be in the range of 100 to 400 nm, e.g., from 150 to 350 nm, from 180 to 300 nm, or from 200 to 250 nm, as determined by laser diffraction and polarization intensity differential scattering (PIDS) using a Beckman Coulter LS 13320 Particle Size Analyzer.

In some embodiments, the solid content of the aqueous polymer dispersion is from 45 to 70 wt. %, from 50 to 65 wt. %, from 50 to 60 wt. %, or from 54 to 56 wt. %.

In some embodiments, the pH of the aqueous polymer dispersion is from 3 to 9, e.g., from 4 to 8, or from 5 to 7.

In some embodiments, the coagulum content of the unfiltered aqueous polymer dispersion, as measured by filtration over a 180 μm sieve, is below 0.02%, below 0.01%, or below 0.005%. In some embodiments, the coagulum content of the aqueous polymer dispersion filtered over a 180 μm sieve, is below 0.02%, below 0.01%, or below 0.005%, as measured by filtration over a 40 μm sieve.

In some embodiments, the Brookfield viscosity of the aqueous polymer dispersion, as measured with spindle 2 at 20 rpm is from 50 to 1500 mPas, e.g., 100 to 1000 mPas, from 150 to 750 mPas, or from 200 to 500 mPas.

### Adhesive Crosslinker

In some embodiments, in addition to the aqueous polymer dispersion described, the adhesive comprises at least one compound capable of reacting with functional groups of the polymer of the polymer dispersion and optionally with functional groups of the polymer film or the substrate, thereby crosslinking the polymer of the polymer dispersion and optionally chemically bonding the polymer of the polymer dispersion to the polymer film and/or the substrate and hence promoting adhesion and cohesion of the adhesive. Due to its reactivity, this cross-linker is not part of the aqueous polymer dispersion and is only added to the polymer of the aqueous polymer dispersion immediately prior to the final lamination application (2K system). Suitable cross-linkers can include epoxy-functional compounds, silane-functional compounds, melamine formaldehyde resins, isocyanate-functional compounds, and/or aziridine-functional compounds, for example.

In preferred embodiments, the adhesive can comprise a cross-linking compound with two or more isocyanate groups, such as a diisocyanate or polyisocyanate, for example. In particularly preferred embodiments, the adhesive comprises a water-soluble or a water-emulsifiable diisocyanate or polyisocyanate.

In some embodiments, the adhesive comprises at least one compound that cross-links the polymer where the at least one cross-linking compound is present in an amount of 0.05 or more, e.g., 0.1 wt. % or more, 0.25 wt. % or more, 0.50 wt. % or more, 1.0 wt. % or more, 1.5 wt. % or more, 2.0 wt. % or more, 3.0 wt. % or more, 4.0 wt. % or more, or 5.0 wt. % or more. In terms of ranges, the adhesive comprises at least one cross-linking compound in an amount from 0.05 to 10 wt. %, e.g., from 0.1 to 8 wt. %, from 0.3 to 7.0 wt. %, from 0.5 to 6.0 wt. %, from 0.7 to 5.0 wt. %, or from 1.0 to 5.0 wt. %, for example.

In some embodiments, after addition of the adhesive cross-linker, the adhesive can have a pot life of at least 1 hour, e.g., at least 2 hours, at least 3 hours, at least 4 hours, at least 6 hours, at least 8 hours, at least 12 hours, at least 18 hours, at least 24 hours, at least 36 hours, at least 48 hours, at least 60 hours, or at least 72 hours.

### Optional Additives

The adhesives can contain additional additives. Some examples of additional additives include fillers, dyes, leveling agents, thickeners (preferably associative thickeners), defoamers, plasticizers, pigments, wetting agents, UV stabilisers, biocides, and tackifiers.

For better wetting of surfaces the adhesives can optionally be used with wetting agents, for example, fatty alcohol ethoxylates, alkylphenol ethoxylates, sulfosuccinic acid esters, polyoxyethylene/propylene, sodium dodecyl sulfonates, or combinations thereof.

When included in the adhesive, a defoaming agent generally reduces or mitigates the formation of foaming in the adhesive when deposited or generally handled or transferred from one location to another. Generally, any defoaming agent that does not interfere with the physical or mechanical properties of the adhesive at the desired defoamer concentration may be used. For instance, the defoaming agent may be mineral-based, silicone-based, or non-silicone-based.

UV stabili7ers include UV absorbers such as 2-(2-Hydroxyphenyl)-2H-benzotriazoles and radical scavengers such as hindered amine light stabili7ers (HALS), where tetramethyl piperidine derivatives are most commonly used.

In terms of lower limits, the adhesive may comprise at least 0.01 parts by weight of at least one additive, based on a total of 100 parts by weight, e.g., at least 0.05 parts by weight or at least 0.1 part by weight. In terms of upper limits, the adhesive may comprise less than 5 parts by weight of at least one additive, based on a total of 100 parts by weight, e.g., less than 1 parts by weight, or less than 0.5 parts by weight. In terms of ranges, the adhesive may comprise from 0.01 to 5 parts by weight of at least one additive, based on a total of 100 parts by weight, e.g., from 0.05 to 1 part by weight, or from 0.1 to 0.5 parts by weight.

### Laminated Products

Some aspects relate to laminated products that comprise the adhesives described herein. The laminated products can comprise, in some aspects, a transparent polymer film, and a substrate, where the adhesive bonds the transparent polymer film to the substrate. Preferred embodiments include dry lamination products where the adhesive is applied onto the polymer film and dried to form a coated film. The substrate (e.g., paper or cardboard) is then laminated onto the coated film, where the lamination is usually done at elevated temperatures and applying pressure.

The transparent polymer film can be, for example, a polyolefin film. The polyolefin film may vary widely. In some embodiments, the polyolefin film may comprise any polyolefin material that exhibits good mechanical strength and heat resistance. Exemplary polyolefin films may comprise at least one of an oriented polypropylene (oPP), unstretched polypropylene (CPP), polyethylene (PE), polyamide (PA), polyethylene terephthalate (PET), polyacetate, cellophane, or combinations thereof. In a preferred embodiment, the polyolefin film is an oriented polypropylene.

The polyolefin films according to certain embodiments of the present invention may comprise a thickness ranging from 5 to 100 microns, preferably 5 to 40 microns.

In a preferred embodiment, the surface of the polyolefin film onto which the adhesive is applied comprises hydrophilic groups, such as oxygen-comprising groups. The hydrophilic groups are preferably generated by corona pre-treatment to improve wetting and to promote adhesion. Typically, a corona treatment of about 10 Watts per square meter and minute is suitable for this purpose. Alternatively or additionally, primers or intermediate layers can optionally be used between polymer film or substrate and adhesive. In addition, the film laminates can have additional functional layers, e.g. barrier layers, printing layers, paint or varnish layers or protective layers. In a preferred embodiment, the polymer film is a corona-pre-treated oPP film.

In certain embodiments, the substrate may be paper, such as cast gloss paper. The adhesives disclosed herein beneficially exhibit good adhesion to cast gloss paper. In other embodiments the substrate can be cardboard or cardstock. In one embodiment, the paper or cardboard is colored or comprises printed matter on the side that is laminated onto the polymer film. The dry coat weight of the adhesives may vary, but is generally within the range from 0.1 to 20 grams per square meter (“gsm”), e.g., from 0.5 to 15 gsm or from 1 to 10 gsm. The coat weight of the adhesive may be adjusted if a specific range for the coat weight or solids content is desired. Generally, a greater coat weight and solids content are desired for an adhesive coated onto paper as compared to a topcoat coated onto a polyolefin film.

### EXAMPLES

### Example 1 (Comparative)

A three (3) liter reactor equipped with a reflux condenser and an anchor stirrer was filled with 520 g of deionized (DI) water. While stirring, the reactor content was heated to 80° C. and 4.2 wt. % of the monomer feed (Table 2) was added. The monomer feed was obtained by mixing the ingredients in Table 2 under stirring. A solution of 0.7 g ammonium persulfate in 13 g of water was next added to the reactor and the reactor contents were held at 80° C. for 15 min.

Subsequently, the remaining amount of the monomer feed was added to the reactor with a constant dosage rate over 180 min. In a parallel feed, 3.3 g ammonium persulfate in 52 g DI water was added to the reactor with a constant dosage rate over 180 min. The reactor temperature was maintained at 80° C. during the feed additions. After completion of the feed additions, the reactor content increased to 85° C. for another 60 minutes and then cooled to 50° C. At 50° C., 0.9 g tert-butylhydroperoxide (TBHP, 70 wt. % in water) in 6.5 g DI water were added to the reactor. Subsequently, 0.7 g of Bruggolit® FF6 M (supplied by L. Briiggemann GmbH & Co. KG) in 13 g DI water was added to the reactor within 30 min. The reactor contents were then cooled to 30° C. The pH of the resulting polymer dispersion was adjusted to about 6.0 with ammonium hydroxide (12.5% in water). Finally, a solution of 6.5 g of adipic dihydrazide in 58.5 g DI water and a solution of 2.4 g Acticide® MV (supplied by Thor GmbH, comprising 1.5 wt % of a 3:1 mixture of 5-chloro-2-methyl-1,2-thiazol-3(2H)-one and 2-methyl-1,2-thiazol-3(2H)-one) in 4.8 g DI water were added to the dispersion.

A polymer dispersion with a solid content of 55.5%, a Brookfield viscosity of 245 mPas (spindle 2, 20 rpm), and a pH of 6.1 was obtained. The coagulum content, as measured by filtration over a 180 μm sieve, was 0.011%. The weight-average particle diameter, as determined by a Beckman Coulter LS 13320 Particle Size Analyzer, was 230 nm. The glass transition temperature, as measured by differential scanning calorimetry (DSC) according to ISO 16805, was −21.2° C.

TABLE 2
Composition of the monomer feed (in grams)

| | Ex. 1-7 |
|---|---|
| DI water | 390 |
| Sodium alkyl ether sulfate, with approx. | 46.5 |
| 7 moles EO, 28% in water | |
| Diacetone acrylamide | 13 |
| Methacrylic acid | 39 |
| Methyl methacrylate (MMA) | 325 |
| n-Butyl acrylate (BA) | 487.5 |
| 2-Ethylhexyl acrylate (EHA) | 487.5 |

### Example 2 (Inventive)

Example 1 was repeated with the following modification: In addition to 520 g of DI water, the reactor pre-charge (before the monomer feed was added) comprised 1.3 g sodium bicarbonate.

A polymer dispersion with a solid content of 55.8%, a Brookfield viscosity of 170 mPas (spindle 2, 20 rpm), and a pH of 6.2 was obtained. The coagulum content, as measured by filtration over a 180 μm sieve, was 0.001%. The weight-average particle diameter, as determined by a Beckman Coulter LS 13320 Particle Size Analyzer, was 270 nm. The glass transition temperature, as measured by differential scanning calorimetry (DSC) according to ISO 16805, was −21.1° C.

### Example 3 (Inventive)

Example 1 was repeated with the following modification: In addition to 520 g of DI water, the reactor pre-charge comprised 3.3 g sodium bicarbonate.

A polymer dispersion with a solid content of 55.6%, a Brookfield viscosity of 200 mPas (spindle 2, 20 rpm), and a pH of 6.3 was obtained. The coagulum content, as measured by filtration over a 180 μm sieve, was 0.001%. The weight-average particle diameter, as determined by a Beckman Coulter LS 13320 Particle Size Analyzer, was 300 nm. The glass transition temperature, as measured by differential scanning calorimetry (DSC) according to ISO 16805, was −20.7° C.

### Example 4 (Inventive)

Example 1 was repeated with the following modification: In addition to 520 g of DI water, the reactor pre-charge comprised 2.6 g sodium acetate (anhydrous).

A polymer dispersion with a solid content of 55.8%, a Brookfield viscosity of 145 mPas (spindle 2, 20 rpm), and a pH of 5.9 was obtained. The coagulum content, as measured by filtration over a 180 μm sieve, was 0.028%. The weight-average particle diameter, as determined by a Beckman Coulter LS 13320 Particle Size Analyzer, was 280 nm. The glass transition temperature, as measured by differential scanning calorimetry (DSC) according to ISO 16805, was −19.9° C.

### Example 5 (Inventive)

Example 1 was repeated with the following modification: In addition to 520 g of DI water, the reactor pre-charge comprised 2.6 g sodium sulfate.

A polymer dispersion with a solid content of 56.0%, a Brookfield viscosity of 240 mPas (spindle 2, 20 rpm), and a pH of 5.9 was obtained. The coagulum content, as measured by filtration over a 180 μm sieve, was 0.042%. The weight-average particle diameter, as determined by a Beckman Coulter LS 13320 Particle Size Analyzer, was 330 nm. The glass transition temperature, as measured by differential scanning calorimetry (DSC) according to ISO 16805, was −19.8° C.

### Example 6 (Inventive)

Example 1 was repeated with the following modification: In addition to 520 g of DI water, the reactor pre-charge comprised 6.5 g disodium hydrogen phosphate dodecahydrate.

A polymer dispersion with a solid content of 56.0%, a Brookfield viscosity of 200 mPas (spindle 2, 20 rpm), and a pH of 6.3 was obtained. The coagulum content, as measured by filtration over a 180 μm sieve, was 0.014%. The weight-average particle diameter, as determined by a Beckman Coulter LS 13320 Particle Size Analyzer, was 230 nm. The glass transition temperature, as measured by differential scanning calorimetry (DSC) according to ISO 16805, was −20.9° C.

### Example 7 (Comparative)

The polymer dispersion of Example 1 was admixed with 3.3 g sodium bicarbonate in 30 g DI water.

Compatibility with Isocyanate Crosslinkers

To evaluate the compatibility with isocyanate crosslinkers, hexamethylene diisocyanate (HDI) was admixed to the polymer dispersions as per Examples 1-7 and the evolution of the Brookfield viscosity was recorded after various waiting times at room temperature. In a first experiment, 10 g HDI were admixed with 500 g polymer dispersion (2 wt % HDI). The results are displayed in Table 3.

The comparative dispersion without any added salt as per Example 1 exhibited lump formation already within 2 hours after addition of the isocyanate. 4 hours after addition, the dispersion almost completely coagulated and large lumps prevented any meaningful measurement of the Brookfield viscosity. 8 hours after addition, the dispersion was completely solid.

While the inventive dispersions as per Examples 2-6 also turned solid 8 hours after addition of the isocyanate crosslinker, they were still liquid 4 hours after addition of the isocyanate and did not experience a significant viscosity increase nor were they prone to lump formation. 4 hours after addition, all dispersions according to Examples 2-6 showed some extent of skin formation at the dispersion-air interface (possibly caused by drying than by a reaction with the isocyanate), while Example 2 with the lowest amount of salt also suffered from some minor sediment formation. 2 hours after addition, all properties of the inventive dispersions were comparable to their properties before the isocyanate addition, while at the same time, the comparative dispersion according to Example 1 already suffered from lump formation and viscosity increase.

Comparative Example 7 with post-added salt exhibited a stability comparable to Comparative Example 1, with significant lump formation within 2 hours after isocyanate addition. This result suggests that the salt needs to be present during polymerization to exert an effect on the isocyanate stability.

TABLE 3
Brookfield viscosities (mPas, spindle 2, 20 rpm) of the polymer
dispersions before and after addition of 2 wt % HDI

| | | 1 min | 1 h | 2 h | 4 h | 8 h |
|---|---|---|---|---|---|---|
| | before | after | after | after | after | after |
| | addition | addition | addition | addition | addition | addition |
| Example 1 | 245 | 355 | 335 | (450) | large | solid |
| (Comp.) | | | | lumps | lumps | |
| Example 2 | 170 | 185 | 160 | 190 | 260 | solid |
| (Inv.) | | | | | minor | |
| | | | | | sediment; | |
| | | | | | skin | |
| Example 3 | 200 | 270 | 160 | 210 | 310 | solid |
| (Inv.) | | | | | skin | |
| Example 4 | 145 | 175 | 135 | 150 | 230 | solid |
| (Inv.) | | | | | skin | |
| Example 5 | 240 | 280 | 235 | 225 | 240 | solid |
| (Inv.) | | | | | skin | |
| Example 6 | 200 | 235 | 195 | 215 | 270 | solid |
| (Inv.) | | | | | skin | |
| Example 7 | 220 | 370 | 350 | lumps | large | solid |
| (Comp.) | | | | | lumps | |

In a second experiment, the amount of HDI, which was admixed to 500 g polymer dispersion, was increased to 25 g (5 wt % HDI). The results are displayed in Table 4. Due to the increased amount of isocyanate, the effects were more pronounced and shifted towards shorter time frames, while the general comparative observations are consistent with the results obtained upon addition of 2 wt % HDI.

The comparative dispersion without any added salt as per Example 1 already exhibited a significant viscosity increase directly after addition of the isocyanate. 1 hour after addition, the viscosity increased further to more than three times the original value and the dispersion was prone to lump formation. 2 hours after addition, the dispersion was completely solid. The comparative dispersion with post-added salt as per Example 7 yielded comparable results.

In contrast, all inventive dispersions with salt in the reactor pre-charge remained liquid until 2 hours after addition of the isocyanate. At that time, Example 2 was free of lumps, Examples 3 and 4 exhibited a small number of small lumps, while Examples 5 and 6 exhibited a small number of larger lumps. The dispersion as per Example 6 was the only inventive dispersion with an increase in viscosity above three times the original value. 1 hour after addition of the isocyanate, all inventive dispersions were free of lumps and had low viscosity.

TABLE 4
Brookfield viscosities of the polymer dispersions
before/after addition of 5 wt % HDI

| | before | 1 min after | 1 h after | 2 h after | 4 h after |
|---|---|---|---|---|---|
| | addition | addition | addition | addition | addition |
| Example 1 | 245 | 620 | 830 | solid | solid |
| (Comp.) | | | lumps | | |
| Example 2 | 170 | 255 | 270 | 325 | solid |
| (Inv.) | | | | | |
| Example 3 | 200 | 295 | 290 | 335 | solid |
| (Inv.) | | | | small lumps | |
| Example 4 | 145 | 225 | 255 | 310 | solid |
| (Inv.) | | | | small lumps | |
| Example 5 | 240 | 320 | 315 | 450 | solid |
| (Inv.) | | | | lumps | |
| Example 6 | 200 | 320 | 440 | 670 | solid |
| (Inv.) | | | | lumps | |
| Example 7 | 220 | 600 | 925 | solid | solid |
| (Comp.) | | | lumps | | |

### Gloss Film Lamination

In gloss film lamination experiments, polypropylene films (oriented polypropylene (oPP), corona pretreated on both sides, 15 μm thickness) were laminated on cardboard.

The oPP films were coated with the polymer dispersions as per Examples 1-7 (no isocyanate added). If necessary, the dispersions were diluted with water to achieve a dry application weight of 8-10 g/m². The oPP films with the dispersion adhesives were then dried in a climatic chamber at 23° C. and 55% relative humidity for 3 hours before laminating a piece of cardboard (325 μm thickness, 236 g/m², printed with black offset ink (Pantone black C)) with its printed side onto the coated film with a laboratory laminator. The laminations were then stored in a climatic chamber at 23° C. and 55% relative humidity for 24 hours.

### Embossing

The laminations were then embossed on the film side for 0.3 seconds at 48-50 bar. The relief stamp for the embossing trials comprised different geometrical shapes, letters, joints, and figures, which were embossed 2 mm into the metal plate. During embossing, a rubber counter mold with a thickness of 1.75 mm was used. The embossings were checked for delamination after 24 hours and 7 days. The embossing strength was rated as follows: 1— embossing is completely in order; 2— embossing is slightly open in some places; 3— embossing is clearly open in individual places; 4— embossing is completely open. The results are shown in Table 5.

To determine the peel strength, the laminations were cut into 25 mm wide strips. The peel force was measured 24 hours after the lamination had been produced. The lamination strip was peeled off at an angle of 180° at a velocity of 50 mm/min.

The small amounts of inorganic salts used in the inventive Examples 2-6 did not negatively affect the adhesive properties of the polymer dispersions, hence yielding comparable values regarding embossing and peel strength to the comparative dispersion without any added salt as per Example 1.

TABLE 5
Embossing/peel

| | Embossing | Embossing | Peel force (N/25 mm at |
|---|---|---|---|
| | after 24 h | after 7 days | 50 mm/min) |
| Example 1 | 1-2 | 2 | 5.0 |
| (Comp.) | | | |
| Example 2 | 1-2 | 1-2 | 4.8 |
| (Inv.) | | | |
| Example 3 | 1-2 | 2 | 5.1 |
| (Inv.) | | | |
| Example 4 | 1-2 | 2 | 5.1 |
| (Inv.) | | | |
| Example 5 | 1-2 | 1-2 | 4.9 |
| (Inv.) | | | |
| Example 6 | 1-2 | 2 | 5.2 |
| (Inv.) | | | |
| Example 7 | 1-2 | 2 | 4.7 |
| (Comp.) | | | |

The following numbered embodiments are contemplated. All combinations of features and embodiments are contemplated.

Embodiment 1: An adhesive for film lamination, the adhesive comprising at least one aqueous polymer dispersion produced by emulsion polymerization, wherein the aqueous polymer dispersion comprises: at least one salt with a solubility in water at standard conditions of greater than 10 g/L, and comprising a cation and an anion, wherein the cation of the salt is selected from ammonium, alkali, and alkaline earth, and where the anion of the salt is selected from sulfate, hydrogen sulfate, phosphate, hydrogen phosphate, dihydrogen phosphate, diphosphate, hydrogen/dihydrogen diphosphate, acetate, carbonate, hydrogen carbonate, nitrate, or halogenide; at least one ethylenically unsaturated monomer incorporated into the polymer with at least one keto or aldehyde group; at least one compound with at least two functional groups that are capable to react with the keto or aldehyde groups, wherein at least a portion of the at least one salt is present during the emulsion polymerization process.

Embodiment 2: An embodiment of any of the other numbered embodiments, wherein the emulsion polymerization comprises a free radically initiated emulsion polymerization.

Embodiment 3: An embodiment of any of the other numbered embodiments, wherein the at least one salt is present in an amount from 0.05 to 0.5 wt. %, preferably from 0.075 to 0.4 wt. %, more preferably from 0.1 to 0.3 wt. %, based on the total weight of the monomer mixture.

Embodiment 4: An embodiment of any of the other numbered embodiments, wherein at least 50 wt. %, preferably 75 wt. %, more preferably all of the at least one salt is present during the emulsion polymerization process, based on the total weight of the at least one salt.

Embodiment 5: An embodiment of any of the other numbered embodiments, wherein the polymer comprises from 0.1 to 5 wt. %, preferably from 0.3 to 3 wt. %, more preferably from 0.5-1.5 wt. %, of the at least one ethylenically unsaturated monomer with at least one keto or aldehyde group, based on the total weight of the polymer.

Embodiment 6: An embodiment of any of the other numbered embodiments, wherein the monomer mixture comprises at least one ethylenically unsaturated stabilizing monomer.

Embodiment 7: An embodiment of any of the other numbered embodiments, wherein the at least one ethylenically unsaturated stabilizing monomer is a carboxylic acid, preferably selected from acrylic acid and methacrylic acid, more preferably methacrylic acid.

Embodiment 8: An embodiment of any of the other numbered embodiments, wherein the at least one ethylenically unsaturated stabilising monomer is present in an amount from 0.5 to 7.5 wt. %, preferably from 1 to 5 wt. %, more preferably from 1.5 to 4 wt. % based on the total weight of the monomer mixture.

Embodiment 9: An embodiment of any of the other numbered embodiments, wherein the polymer comprises methacrylic and acrylic acid esters, wherein the methacrylic acid ester is preferably methyl methacrylate and the acrylic acid esters are preferably selected from n-butyl acrylate and 2-ethylhexyl acrylate.

Embodiment 10: An embodiment of any of the other numbered embodiments, wherein the polymer comprises n-butyl acrylate and 2-ethylhexyl acrylate.

Embodiment 11: An embodiment of any of the other numbered embodiments, wherein the polymer comprises at least 90 wt. % of methacrylic and acrylic acid esters, based on the total weight of the polymer.

Embodiment 12: An embodiment of any of the other numbered embodiments, wherein the at least two functional groups of at least one compound with at least two functional groups that are capable to react with the keto or aldehyde groups are hydrazide groups.

Embodiment 13: An embodiment of any of the other numbered embodiments, wherein the at least one compound with at least two functional groups that are capable to react with the keto or aldehyde groups are present in an amount such that the molar ratio of said keto groups to said functional groups is 0.5 to 2, preferably 0.75 to 1.33, more preferably 0.9 to 1.1.

Embodiment 14: An embodiment of any of the other numbered embodiments, wherein the polymer has a glass transition temperature of −10 to −30° C., preferably −15 to −25° C., as determined by differential scanning calorimetry according to ISO 16805.

Embodiment 15: An embodiment of any of the other numbered embodiments, wherein the weight average particle size of the polymer dispersion is in the range of from 150 to 350 nm, preferably in the range of from 180 to 300 nm, as measured by laser diffraction and polarization intensity differential scattering (PIDS) using a Beckman Coulter LS 13320 Particle Size Analyzer.

Embodiment 16: An embodiment of any of the other numbered embodiments, wherein the solid content of the polymer dispersion is from 50 to 60%, preferably from 53 to 57%, more preferably from 54 to 56%.

Embodiment 17: An embodiment of any of the other numbered embodiments, wherein the Brookfield viscosity of the polymer dispersion, measured with spindle 2 at 20 rpm, is below 1500 mPas, preferably below 1000 mPas, more preferably from 200 to 700 mPas.

Embodiment 18: An embodiment of any of the other numbered embodiments, wherein the coagulum content of the unfiltered polymer dispersion, as measured by filtration over a 180 μm sieve, is below 0.02%, preferably below 0.01%.

Embodiment 19: An embodiment of any of the other numbered embodiments, wherein the aqueous polymer dispersion does not contain protective colloids.

Embodiment 20: An embodiment of any of the other numbered embodiments, wherein the aqueous polymer dispersion does not contain nonionic emulsifiers.

Embodiment 21: An embodiment of any of the other numbered embodiments, wherein the polymer does not contain ethylenically unsaturated monomers with a hydroxyl group.

Embodiment 22: An embodiment of any of the other numbered embodiments, wherein the adhesive comprises 0.1-5 wt. % of a compound with at least two isocyanate groups.

Embodiment 23: An embodiment of any of the other numbered embodiments, wherein the adhesive is used for high gloss film lamination.

Embodiment 24: A laminated product comprising: a substrate; a transparent polymer film; the adhesive of any of the preceding claims; wherein the adhesive bonds the transparent polymer film to the substrate.

Embodiment 25: An embodiment of any of the other numbered embodiments, wherein the substrate comprises paper or cardboard.

Embodiment 26: An embodiment of any of the other numbered embodiments, wherein the laminated product further comprises at least one additive, preferably wherein the at least one additive is a filler, dye, leveling agent, thickener, defoamer, plasticizer, pigment, wetting agent, UV stabilizer, biocide, tackifier, or combinations thereof.

While the invention has been described in detail, modifications within the spirit and scope of the invention will be readily apparent to those of skill in the art. It should be understood that aspects of the invention and portions of various embodiments and various features recited herein and/or in the appended claims may be combined or interchanged either in whole or in part. In the foregoing descriptions of the various embodiments, those embodiments which refer to another embodiment may be appropriately combined with other embodiments as will be appreciated by one of ordinary skill in the art. Furthermore, those of ordinary skill in the art will appreciate that the foregoing description is by way of example only, and is not intended to limit the invention.

1. An adhesive for film lamination, the adhesive comprising at least one aqueous polymer dispersion produced by emulsion polymerization, wherein the aqueous polymer dispersion comprises:
at least one salt with a solubility in water at 20° C. of greater than 10 g/L, and comprising a cation and an anion, wherein the cation of the salt is selected from ammonium, alkali, and alkaline earth, and where the anion of the salt is selected from sulfate, hydrogen sulfate, phosphate, hydrogen phosphate, dihydrogen phosphate, diphosphate,
hydrogen/dihydrogen diphosphate, acetate, carbonate, hydrogen carbonate, nitrate, or halogenide;
at least one ethylenically unsaturated monomer incorporated into the polymer with at least one keto or aldehyde group;
at least one compound with at least two functional groups that are capable to react with the keto or aldehyde groups,
wherein at least a portion of the at least one salt is present during the emulsion polymerization process.

2. The adhesive of claim 1, wherein the at least one salt is present in an amount from 0.05 to 0.5 wt. % based on the total weight of the monomer mixture.

3. The adhesive of claim 1, wherein at least 50 wt. % of the at least one salt is present during the emulsion polymerization process, based on the total weight of the at least one salt.

4. The adhesive of claim 1, wherein the polymer comprises from 0.1 to 5 wt. % of the at least one ethylenically unsaturated monomer with at least one keto or aldehyde group, based on the total weight of the polymer.

5. The adhesive of claim 1, wherein the monomer mixture comprises at least one ethylenically unsaturated stabilizing monomer.

6. The adhesive of claim 1, wherein the polymer comprises methacrylic and acrylic acid esters.

7. The adhesive of claim 1, wherein the at least two functional groups of at least one compound with at least two functional groups that are capable to react with the keto or aldehyde groups are hydrazide groups.

8. The adhesive of claim 1, wherein the at least one compound with at least two functional groups that are capable to react with the keto or aldehyde groups are present in an amount such that the molar ratio of said keto groups to said functional groups is 0.5 to 2.

9. The adhesive of claim 1, wherein the polymer has a glass transition temperature of −10 to −30° C. as determined by differential scanning calorimetry according to ISO 16805.

10. The adhesive of claim 1, wherein the weight average particle size of the polymer dispersion is in the range of from 150 to 350 nm; as measured by laser diffraction and polarization intensity differential scattering (PIDS) using a Beckman Coulter LS 13320 Particle Size Analyzer.

11. The adhesive of claim 1, wherein the aqueous polymer dispersion does not contain protective colloids or nonionic emulsifiers.

12. The adhesive of claim 1, wherein the polymer does not contain ethylenically unsaturated monomers with a hydroxyl group.

13. The adhesive of claim 1, wherein the adhesive comprises 0.1-5 wt. % of a compound with at least two isocyanate groups.

14. The adhesive of claim 1, wherein the adhesive is used for high gloss film lamination.

15. A laminated product comprising:
a substrate,
a transparent polymer film;
the adhesive of claim 1;
wherein the adhesive bonds the transparent polymer film to the substrate.

16. The adhesive of claim 1, wherein all of the at least one salt is present during the emulsion polymerization process, based on the total weight of the at least one salt.

17. The adhesive of claim 5, wherein the at least one ethylenically unsaturated stabilizing monomer is selected from acrylic acid and methacrylic acid.

18. The adhesive of claim 6, wherein the methacrylic acid ester is methyl methacrylate and the acrylic acid esters are selected from n-butyl acrylate and 2-ethylhexyl acrylate.

19. The adhesive of claim 1, wherein the emulsion polymerization comprises a free radically initiated emulsion polymerization.

20. The adhesive of claim 1, wherein the solid content of the polymer dispersion is from 50 to 60 wt. %.
